(19) United States
(12) Patent Application Publication
(10) Pub. No.: US 2013/0220581 A1
(43) Pub. Date: Aug. 29, 2013

(54) FORWARD OSMOSIS WITH AN ORGANIC OSMOLYTE FOR COOLING TOWERS

(71) Applicant: HYDRATION SYSTEMS, LLC, (US)

(72) Inventors: John R. Herron, Corvallis, OR (US); Upen J. Bharwada, Scottsdale, AZ (US); Isaac V. Farr, Corvallis, OR (US)

(73) Assignee: HYDRATION SYSTEMS, LLC, Scottsdale, AZ (US)

(21) Appl. No.: 13/776,329

(22) Filed: Feb. 25, 2013

Related U.S. Application Data
(60) Provisional application No. 61/602,509, filed on Feb. 23, 2012.

(51) Int. Cl. C09K 5/10; F28F 19/01; C02F 1/44

(52) U.S. Cl. CPC C09K 5/10; C02F 1/445; F28F 19/01
USPC 165/104.28; 210/321.6; 210/243; 261/3

(57) ABSTRACT

A system is described in which a cooling tower is operated with a solution of a non-volatile organic molecule osmolyte and water. Makeup water for the tower is provided by forward osmosis using the fluid as the draw solution for the extraction of water from feeds which require dewatering or from low value available water.

### CROSS REFERENCE TO RELATED APPLICATIONS

This application claims priority to U.S. provisional application Ser. No. 61/602,509 filed Feb. 23, 2012, the entire disclosure of which is hereby incorporated by reference.

### FIELD OF THE INVENTION

The processes and systems described herein relate to cooling systems for use in various industrial processes, such as power plants and petrochemical refineries.

### SUMMARY OF THE INVENTION

Disclosed herein is a process and system for use in and with heat exchanger and cooling tower systems for cooling process fluids. The process and system disclosed utilizes a solution of water and an organic osmolyte as cooling tower water, and optionally at least a portion of the cooling tower water is obtained by extraction of water from solutions which need to be dewatered, such as landfill leachate; oil and/or gas drilling mud, produced water and flowback water; refinery wastewater; pulp and/or paper manufacturing wastewater; pharmaceutical processing wastewater; water obtained from concentrating foods; water obtained from concentrating pharmaceuticals, or from low value waters such as seawater. In the invention, the cooling water in the tower/heat-exchanger loop is replaced by a solution of water and a non-volatile organic osmolyte such as ethylene glycol or glycerin.

In the cooling tower, water will evaporate from the osmolyte solution, cooling the fluid and increasing the proportion of the osmolyte in the solution, i.e., concentrating the osmolyte. To replace the water lost via evaporation, the concentrated osmolyte solution is then supplemented with water having a lower osmotic strength than the osmolyte solution. The water which replaces the water lost via evaporation is known as “makeup water”. In the disclosed process, the makeup water is obtained by means of a forward osmosis membrane device, which produces substantially pure water that is combined with the concentrated osmolyte solution, resulting in a cooled and diluted osmolyte solution. This cooled and diluted solution may then be re-circulated back through a heat exchanger loop, to absorb heat from the process fluid, resulting in the solution becoming heated. The heated solution is then cooled in a cooling tower.

The disclosed use of an organic solute draw solution substantially eliminates corrosion and scaling challenges in the cooling tower, and significantly decreases or eliminates the need to use water from high quality sources to operate the cooling towers.

### BRIEF DESCRIPTION OF THE DRAWINGS

FIG. 1 is a process flow diagram of a system according to an embodiment of the invention.

FIG. 2 is a schematic diagram of an electrodialysis cell that may be used to continuously desalt a sidestream of the circulating osmolyte.

FIG. 3 is a process flow diagram of an experimental system according to an embodiment of the invention.

FIGS. 4A through 4D are graphs plotting heat capacity and heat transfer rates in the cooling tower and heat exchanger for both water and a 35% glycerol solution during operation of an experimental system according to an embodiment of the invention.

FIG. 5 is a graph illustrating cooling tower performance over time during operation of an experimental system according to an embodiment of the invention.

FIG. 6 is a graph illustrating average FO water flux over time during operation of an experimental system according to an embodiment of the invention.

### DETAILED DESCRIPTION OF THE INVENTION

Power plants, petrochemical refineries, and numerous other industrial processes consume large amounts of water for cooling. Typically, the cooling is effected by passing the process fluid through a heat exchanger and absorbing its heat into cool water which is also circulated through the heat exchanger. The warm water exiting the heat exchanger is then typically re-cooled by introducing it into a cooling tower, where it is contacted by large amounts of air, and evaporation of a portion of the water cools the bulk of the water for reuse. The water that is introduced into the cooling tower is often referred to as “cooling tower water”. Water must be continually added to the cooling tower water, to make up for evaporation losses. This added water is referred to as “makeup water.”

Described herein are processes and systems for use in or with cooling towers, in which the water typically used for cooling the process fluid is replaced with a solution of an osmolyte and water. More particularly, the cooling tower water is replaced with a solution of an organic osmolyte and water. In another embodiment of the invention, the processes and systems further utilize a forward osmosis (FO) element for diluting the concentrated osmolyte solution leaving the cooling tower. The diluted osmolyte solution is then circulated back to the heat exchanger.

The present invention advantageously prevents the build up of impurities such as salts in the cooling tower, and also prevents corrosion of the cooling tower and related equipment. The source of impurities tend to be impurities such as salts in the feed water itself, as well as impurities from dust and pollution in the air and from corrosion of the cooling tower system. The invention also dispenses with the need to intermittently discharge or “blow down” a portion of the cooling water in order to control corrosion and keep the towers from salting up. In addition, the invention provides a more economical and environmentally friendly method for using a cooling tower, by substantially lowering the amount of fresh water that would otherwise be needed to operate the cooling tower.

Disclosed herein is a method for cooling hot process fluid, comprising the following steps: (a) conveying through a first side of a heat exchanger the hot process fluid, and conveying through a second side of the heat exchanger an organic osmolyte solution which absorbs heat from the hot fluid; (b) conveying the organic osmolyte solution to a cooling tower; (c) diluting the organic osmolyte solution with water produced by a forward osmosis element, to produce diluted osmolyte solution; and (d) conveying diluted osmolyte solution through the second side of the heat exchanger.

In a preferred embodiment of the invention, the water produced by the forward osmosis element is extracted from a membrane bioreactor; sea water; landfill leachate; oil drilling mud; gas drilling mud; produced water; flowback water; refinery wastewater; pulp manufacturing wastewater; paper manufacturing wastewater; pharmaceutical processing wastewater; water obtained from concentrating food substances; and water obtained from concentrating pharmaceuticals.

In a particularly preferred embodiment of the invention, the organic osmolyte is liquid in its pure state at ambient temperatures. Nonlimiting examples of organic osmolytes that may be utilized in the invention are one or more selected from the group consisting of the following: trimethylamine N-oxide (TMAO), dimethylsulfoniopropionate, trimethylglycine, sarcosine, glycerophosphorylcholine, myo-inositol, taurine, betaines, amino acids, polyols, monosaccharides, disaccharides, polysaccharides, methylamines, methylsulfonium compounds, urea and glyceryl triacetate, polyvinyl alcohol, neoagarobiose, trehalose, and natural extracts.

More particularly, the following are nonlimiting examples of the organic omolytes. The amino acid may be selected from the group consisting of Histidine, Alanine, Isoleucine, Arginine, Leucine, Asparagine, Lysine, Aspartic acid, Methionine, Cysteine, Phenylalanine, Glutamic acid, Threonine, Glutamine, Tryptophan, Glycine, Valine, Ornithine, Proline, Selenocysteine, Serine, Taurine and Tyrosine; the polyol may be selected from the group consisting of ethylene glycol, propylene glycol, glycerol and polyethylene glycol; the monosaccharide may be selected from the group consisting of glucose and fructose; the disaccharide is selected from the group consisting of sucrose and lactose; the polysaccharide may be selected from the group consisting of cellulose, polydextrose and amylose; and the natural extract may be selected from quillaia and lactic acid.

The method may include an optional step of subjecting the diluted osmolyte to electrodialysis to remove excess salts.

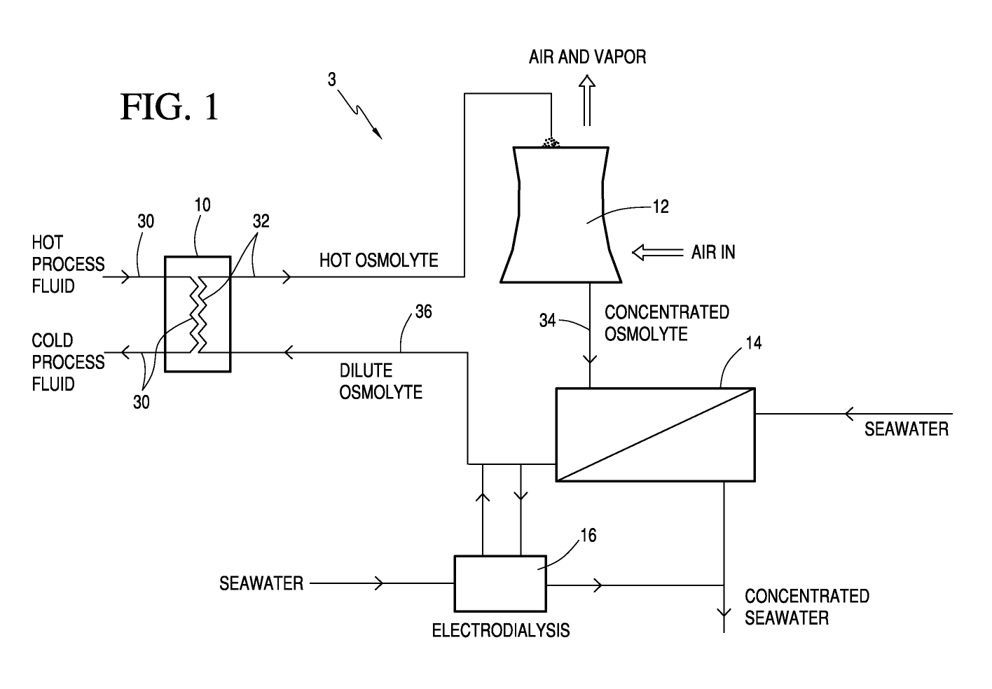

Also disclosed herein is a forward osmosis system for use with a heat exchanger and a cooling tower using an organic osmolyte solution as cooling tower water, the system comprising a forward osmosis membrane element for diluting a stream of organic osmolyte solution exiting the cooling tower. More particularly, the forward osmosis membrane element uses a feed solution for the forward osmosis membrane element selected from the group consisting of: membrane bioreactor water; sea water; landfill leachate; oil drilling mud; gas drilling mud; produced water; flowback water; refinery wastewater; pulp manufacturing wastewater; paper manufacturing wastewater; pharmaceutical processing wastewater; water obtained from concentrating food substances; and water obtained from concentrating pharmaceuticals. FIG. 1 illustrates an exemplary embodiment of the system and process, wherein the feed solution is sea water.

Referring to FIG. 1, also disclosed herein is a cooling tower system comprising: (a) a heat exchange loop comprising a heat exchanger 10 having a first side and a second side, and a first conduit 30 for conveying hot process fluid through the first side of the heat exchanger; (b) a cooling tower 12; (c) a second conduit 32 for conveying an organic osmolyte solution through the second side of the heat exchanger 10 into the cooling tower 12; (d) a forward osmosis membrane element 14 for producing dilute organic osmolyte solution; (e) a third conduit 34 for conveying concentrated organic osmolyte solution exiting the bottom of the cooling tower 12 to the forward osmosis membrane element 4; and a fourth conduit 36 for conveying diluted organic osmolyte solution exiting the forward osmosis membrane element 14 to the second side of the heat exchanger 10.

Optionally, the cooling tower system may further comprise an electrodialysis unit 16 for removing salts from diluted organic osmolyte solution exiting the forward osmosis membrane element 14.

Forward Osmosis Membrane Element Devices

Forward osmosis membrane element devices are made up of two chambers separated by a semipermeable membrane. The membrane allows the passage of water but fundamentally inhibits the transfer of other species. When the chambers are filled with fluids of differing osmotic strength, water is drawn through the membrane from the fluid of lower osmotic strength to the fluid of higher osmotic strength. In this invention, the osmolyte—water solution from the cooling tower is at a much higher osmotic strength than the source water (food product, wastewater or seawater), so when the two are introduced to a forward osmosis device, substantially pure water is transferred from the source water into the osmolyte solution. This water transfer provides the make-up water for the cooling tower.

The preferred forward osmosis membranes used have salt rejection characterized as reverse osmosis or nanofiltration grade. The specified feature of the membranes is that they allow osmotic water passage while substantially impeding the passage of salt. Non-limiting examples of such membranes are: cellulose ester membranes, thin film composite membranes such as polyamide/polysulfone, PBI membranes, and polyether sulfone composite membranes. The membranes can be packaged in any form, including but not limited to hollow fiber, spiral wound, or plate and frame configurations.

While the forward osmosis membranes substantially impede the passage of salts, they do not completely impede the salts. Therefore, salts can contaminate the water-osmolyte solution. To remedy this, the water-osmolyte solution can be desalted using electrodialysis.

Osmolyte

The osmolyte in the water-osmolyte solution used as the cooling tower water is preferably an organic molecule which is highly soluble in water and has both a high osmotic potential and a high diffusivity in water. Still more preferably, the osmolyte is a non-polar organic osmolyte. Most osmolytes are solids until dissolved in water, with the remainder being in the liquid state even without being dissolved in water. The osmolyte molecule should also be substantially impermeable to forward osmosis membranes and have a low vapor pressure. A single osmolyte may be used, or a combination of two or more osmolytes may be used.

Non-limiting examples of effective osmolytes for use in the process of the invention include: Organic osmolyte examples: trimethylamine N-oxide (TMAO), dimethylsulfoniopropionate, trimethylglycine, sarcosine, glycerophosphorylcholine, myo-inositol, taurine, betaines, amino acids (e.g., Histidine, Alanine, Isoleucine, Arginine, Leucine, Asparagine, Lysine, Aspartic acid, Methionine, Cysteine, Phenylalanine, Glutamic acid, Threonine, Glutamine, Tryptophan, Glycine, Valine, Ornithine, Proline, Selenocysteine, Serine, Taurine, or Tyrosine), polyols (e.g., ethylene glycol, propylene glycol, glycerol (glycerin) or polyethylene glycol), monosaccharides (e.g., glucose or fructose), disaccharides (e.g., sucrose or lactose), polysaccharides (e.g., cellulose, polydextrose or amylose), methylamines, methylsulfonium compounds, urea and glyceryl triacetate, polyvinyl alcohol, neoagarobiose, trehalose, and natural extracts (e.g., quillaia or lactic acid).

In a preferred embodiment of the invention, osmolytes that are liquids in the pure state, i.e., are liquids even when not dissolved in water, are used, because they cannot crystallize in the cooling tower under any circumstances. Glycerol (glycerin) and ethylene glycol are preferred osmolytes, because they remain liquids at all levels of hydration.

Case 1: Seawater or Brackish Water Source for Makeup Water

A schematic of a forward osmosis system for extracting cooling water from seawater or brackish water according to an embodiment of the invention is shown in FIG. 1. This proposed system has an electrodialysis unit or cell on a side stream to desalt the osmolyte.

Desalting of Osmolyte

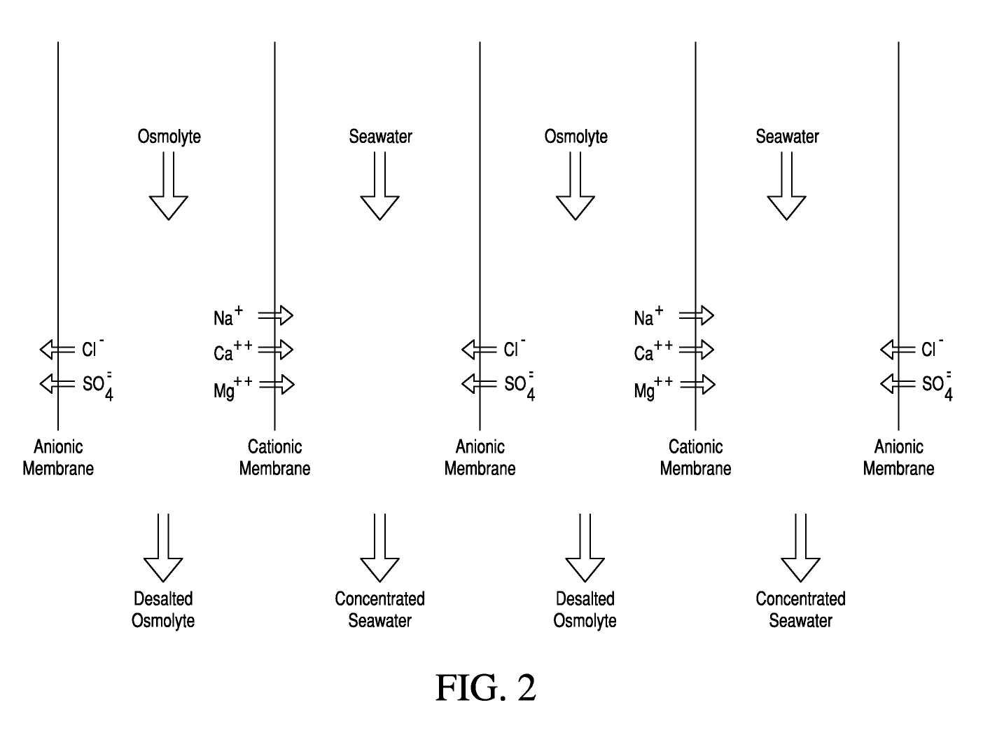

Forward osmosis membranes are not 100% effective in blocking salt migration from seawater to the osmolyte. Therefore, over an extended period salts will accumulate in the water-osmolyte solution. To control the build-up of salt, an electrodialysis cell can optionally be added to continuously desalt a side-stream of the circulating osmolyte. A diagram of the proposed cell is shown in FIG. 2. This process will not reduce the salt levels in the system to zero but it can be sized to hold salts at a level which keeps corrosion at minimal levels.

Case 2: Osmotic Membrane Bioreactor Source for Makeup Water

To provide cooling make-up water from a source which would otherwise be wastewater, it is proposed that the cooling tower be coupled with an osmotic membrane bioreactor (OsMBR) for wastewater treatment.

Commonly, membrane bioreactors (MBRs) remove water from sewage to improve digestion and reduce acreage of treatment facilities. Membranes used are typically microfiltration grade and water is extracted by suction on the permeate side of the membrane. This design is effective in concentrating suspended solids in sewage; however, dissolved solids pass easily through the microfiltration membrane. Also, in sewage treatment applications, microfiltration membranes foul easily. Therefore, to keep solids swept away from the membrane surface the membranes are mounted vertically and air is bubbled aggressively across their surface.

An alternative to traditional MBR is the use of forward osmosis to dewater the sewage (OsMBR). In this application, sewage is contacted to one side of a reverse-osmosis-grade forward osmosis membrane and a draw solution is contacted to the other side. Osmosis causes water to move from the sewage through the membrane into the draw solution, while all suspended solids and substantially all dissolved solids are blocked by the membrane. Water permeating the membrane is of a much higher purity than water extracted by microfiltration, and fouling rates are orders of magnitude slower than those in microfiltration.

Two significant challenges with OsMBR are firstly, during operation the draw solution becomes diluted and must be replaced or reconcentrated to keep the process operating, and secondly, the inorganic salts typically used as the solute in the FO draw solution can slowly migrate into the sewage and cause difficulties by interfering with and negatively affecting microbiological action. To address the first challenge, it is proposed that the draw solution be reconcentrated by using it as the draw solution in a cooling tower, so that the water extracted from the sludge becomes the makeup water for the cooling tower. This permits re-use of water, which is particularly beneficial in geographic areas where make-up water is expensive or in short supply. To address the second challenge or difficulty, it is proposed that the draw solution be made up of an organic osmolyte molecule instead of an inorganic salt. Any draw solute which migrates to the sludge is not expected to negatively affect the microbial action (and in fact may promote beneficial microbial action by serving as a food source for the microbes). Further, the water-osmolyte solution is biodegradable and will not contaminate the sludge.

The use of an organic solute draw solution also substantially eliminates corrosion and scaling challenges in the cooling tower.

Case 3: Food Concentration Source for Makeup Water

Food products can also be dewatered by the forward osmosis process (FO). Extracting cooling make-up water from a food that requires concentration would have double benefits, because it would eliminate the energy used in the food dewatering process and provide a source of cooling make-up water. Commonly, food products such as concentrated orange juice or tomato paste are dewatered by evaporation, which requires large amounts of energy (natural gas). The evaporation also has adverse effects on the food quality, due to the application of heat and the loss of volatile aromas.

In this application, the food is contacted to one side of a forward osmosis membrane and a draw solution is contacted to the other side. Osmosis causes water to move from the food through the membrane into the draw solution, while all suspended solids and substantially all dissolved solids are blocked by the membrane. The forward osmosis process retains volatiles in the food and can operate at low temperatures, such as for heat-sensitive products. Unlike reverse osmosis, FO does not produce water directly. Water removed from the food passes into a draw solution, which in turn needs to be reconcentrated.

If the reconcentration is effected by a cooling tower, in addition to reducing energy for the food concentration and supplying make-up water for the cooling tower, the use of an organic solute draw solution also substantially eliminates corrosion and scaling challenges in the cooling tower.

Example: Cooling Tower/FO Study with 35% Glycerol

Experimental System

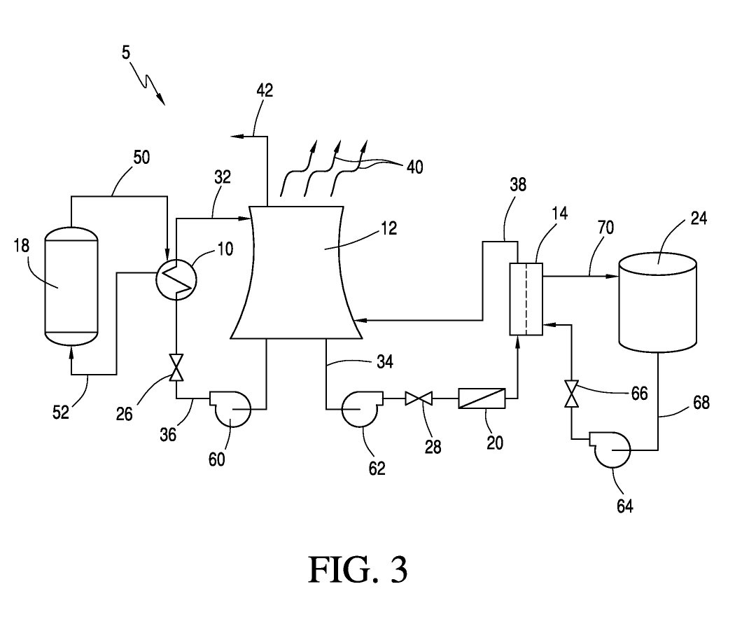

An experimental system according to an embodiment of the system of the invention was assembled, and is illustrated in FIG. 3. The experimental system 5 comprised four loops, a heating loop, a cooling loop, a FO draw solution loop, and a FO feed loop.

The heating loop is comprised of a boiler 18, a heat exchanger 10, a first heating loop conduit 50 through which heated fluid is circulated from the boiler 18 to a first side of the heat exchanger 10, and a second heating loop conduit 52 through which cooled fluid is circulated from the first side of the heat exchanger 10 to the boiler 18.

The cooling loop is comprised of a cooling tower 12, the heat exchanger 10, a first cooling loop conduit 36 through which concentrated, cooled osmolyte solution is circulated from the bottom of the cooling tower 12 through a second side of the heat exchanger 10, and a second cooling loop conduit 32 through which heated osmolyte solution leaving the second side of the heat exchanger 10 is circulated to the cooling tower 12. The cooling loop is further comprised of a first cooling loop pump 60 in line with the first cooling loop conduit, for assisting in circulation of a portion of the concentrated, cooled osmolyte from the bottom of the cooling tower 12 to the heat exchanger 10.

The FO draw loop is comprised of a FO filter element 14 incorporating an FO membrane element 14, a cartridge filter 20, a first FO draw loop conduit 34 through which concentrated, cooled osmolyte solution is circulated from the bottom of the cooling tower 12 through the cartridge filter 20, and a second FO draw loop conduit 38 through which diluted osmolyte solution is circulated from the FO element 14 to the cooling tower 12. Osmolyte solution in conduit 34 enters the element 14 and leaves through conduit 38, all the while remaining on one side (the left side, as illustrated in FIG. 3) of the FO membrane filter in element 14. The FO draw loop is further comprised of a FO draw loop pump 62 in line with the first draw loop conduit 34, for assisting in circulation of a portion of the concentrated, cooled osmolyte from the bottom of the cooling tower 12 to the cartridge filter 20. Within cooling tower 12 is a float valve (not shown) which stopped the flow of diluted osmolyte solution into the cooling tower 12 when there was a sufficient amount of diluted solution in the tower. (However, instead of a float valve within the cooling tower, it is possible to have a valve in line with the second FO draw loop conduit 38.) Arrows 40 represents evaporative losses, and arrow 42 represents drift losses, respectively, from the cooling tower 12.

The FO feed loop is comprised of a feed tank 24 and a first FO feed loop conduit 68 through which water or water solution having a lower osmotic pressure than the concentrated osmolyte solution is circulated from the feed tank 24 to the FO filter element 14. The FO feed loop is further comprised of a FO feed loop pump 64 and a FO feed loop pump valve 66, both of which are in line between feed tank 24 and element 14. Pump 64 is located between feed tank 24 and valve 66, and valve 66 is located between pump 64 and element 14. The FO feed loop is further comprised of a second FO feed loop conduit 70 through which water (from feed tank 24) which did not pass thorough the FO membrane into the FO draw loop exits the FO membrane element 14 and is circulated back to the feed tank 24. Thus, concentrated osmolyte solution in conduit 68 enters the element 14 and leaves through conduit 70, all the while remaining on one side (the right side, as illustrated in FIG. 3) of the FO membrane filter element 14.

The purpose of the heating loop was to simulate a process requiring a cooling tower and consisted of a boiler 18 which heated water and circulated it on one side of a heat exchanger 10. In the cooling loop, 35% glycerol (the osmolyte) was pumped out of the basin of the cooling tower 12 and through the second side of the heat exchanger 10 where it cooled the boiler water. After exiting the heat exchanger 10, the 35% glycerol was sprayed over the packing at the top of the cooling tower 12 and allowed to flow back across the countercurrent of air pulled by a fan at the top of the tower 12 and down into the cooling tower's basin. The glycerol solution was cooled as it flowed back toward the basin through sensible heat transfer and evaporative cooling. Water was lost from the system 5 in this step through evaporation and drift loss (which includes losses due to leaks and splashing out of the basin). Glycerol was only lost through drift loss as it does not evaporate at the temperatures present in the system.

In the FO draw solution loop, the glycerol solution was pulled from the basin of the cooling tower 12, pumped through a cartridge filter 20 and then across one side of a FO membrane in the FO membrane element 14. The glycerol solution pulled water from the FO feed loop across the membrane. The water that was pulled across the membrane acted as makeup water to replace what was lost from the cooling tower 12 as evaporation and drift.

After leaving the FO membrane element 14, the diluted glycerol solution flowed through a float valve 22 and back into the basin of the cooling tower 12. When the basin was full, the float valve 22 closed so that the FO element 14 only operated when more water was needed.

In the FO feed loop, water was pumped from a feed tank 24, through the FO membrane in element 14 and back into the feed tank 24. The feed solution can be made up of any water with a lower osmotic pressure than that of the glycerol, but in this experimental system, the feed solution was tap water.

Cooling Capacity

The first tests conducted with the 35% glycerol were designed to determine the heat transfer and cooling efficiency of the glycerol solution compared to that of water. In order to test the heat uptake characteristics of the fluids in the system the cooling loop was run with hot water in the heat exchanger and the tower fan powered off. Temperature data was taken every 30 seconds until the water entering the heat exchanger reached 90° F. The rate of temperature increase was then used to calculate energy flow in BTU/min using the equation:

$$Δ {E}_{hx} = \frac{Δ T * V * ρ * {C}_{p}}{Δ t} \qquad ( 1 )$$

where ΔEₕₓ is the change in the energy in the solution in BTU/min, ΔT is the change in temperature in ° C., V is the system volume in mL, ρ is the density of the solution in g/mL, Cₚ is the specific heat capacity of the fluid in BTU/g*° C., and Δt is the change in time. Based on this equation the glycerol solution was able to absorb 1529 BTU/min while the water was able to absorb 1338 BTU/min. These numbers should only be considered an estimate as the changes in heat capacity and density with increasing temperature were not considered.

After testing heat uptake the cooling capacity of the fluids was tested by turning on the cooling tower fan and monitoring the temperature drop until it reached a constant temperature. This drop in temperature was used to calculate the number of BTUs removed from the system according to the equation:

$$Δ {E}_{ct} = \frac{- Δ T * V * ρ * {C}_{p} + Δ {E}_{hx} * Δ t}{Δ t} \qquad ( 2 )$$

where ΔE_{ct} is the amount of energy removed by the cooling tower in BTUs and all other variables are the same as those defined for equation 1. Note that the negative sign added before ΔT is used so that the returned value is positive instead of negative. Also, the addition of the ΔEₕₓ+Δt term was added to account for the heat added to the solution through the heat exchanger during the cooling process. The rate of heat removal for the two solutions was essentially equal with the glycerol removing an average of 115,693 BTU/hr and the water removing an average of 118,372 BTU/hr. Converted to tons of cooling this works out to between 9.7 and 9.9 tons of cooling. This is above the rated capacity of 8 tons of cooling provided by the manufacturer but given the favorable conditions (ambient temperature 66° F., wet bulb temp, 59° F.) getting almost 10 tons of cooling from the tower seems reasonable. It is also worth noting that the minimum temperature reached by the water was about 1° F. lower than that of the glycerol solution (59° F. vs 58° F.). While this difference seems small it may have an impact on the economics of a large system or a system operating in a more challenging environment

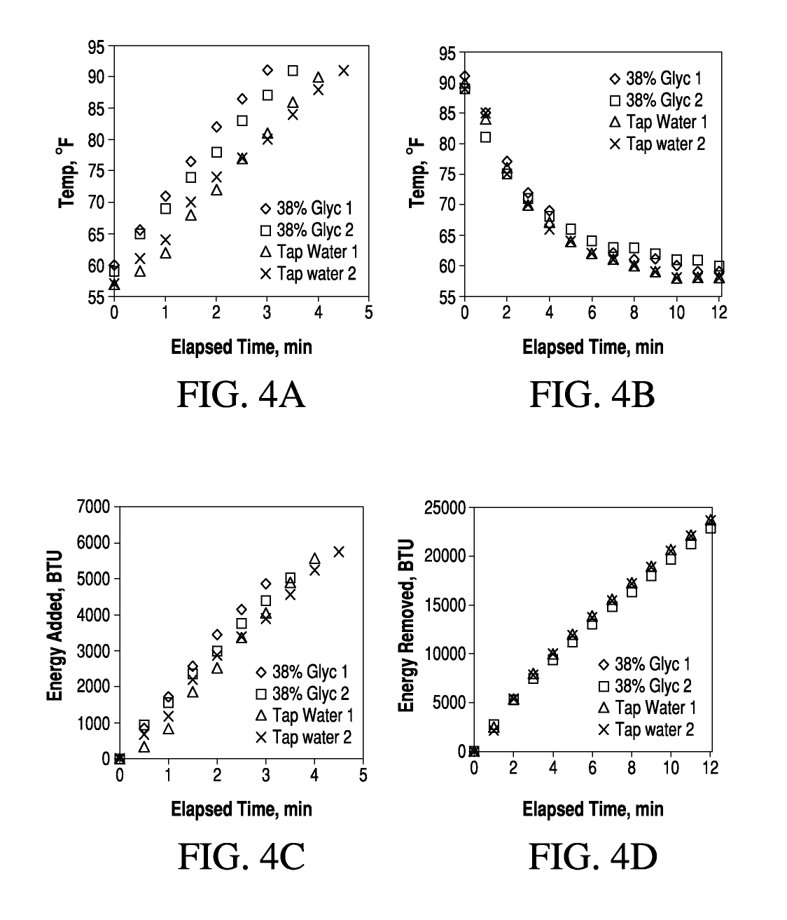

Graphs from the foregoing experiments, along with a summary of the data collected are presented in FIGS. 4A through 4D. Table 1 presents the data in tabular form. Each of the experiments was run twice.

FIGS. 4A and 4C represent the first step of the experiment, where the water or 38% glycerol was heated to 90° F. FIGS. 4B and 4D represent the second step of the experiment, wherein the fan in the cooling tower was turned on and the system was allowed to cool off to a steady state temperature. FIGS. 4A and 4B show the data in terms of system temperature, whereas FIGS. 4C and 4D show the data in terms of energy moved.

Table 1 presents the heat transfer rates for water and 35% glycerin in the cooling tower.

TABLE 1
Heat absorption and removal rates for water and a 38% solution
of glycerol. Each experiment was conducted twice.

| | 38% Glycerol | | Water | |
|---|---|---|---|---|
| | Average | Stdev | Average | Stdev |
| Heat Absorption Rate, | 1,529 | 132 | 1,338 | 83 |
| BTU/hr | | | | |
| Heat Removal Rate, | 115,653 | 1,665 | 118,372 | 598 |
| BTU/hr | | | | |
| Heat Removal Rate, | 9.64 | 0.14 | 9.86 | 0.05 |
| tons | | | | |

System Performance

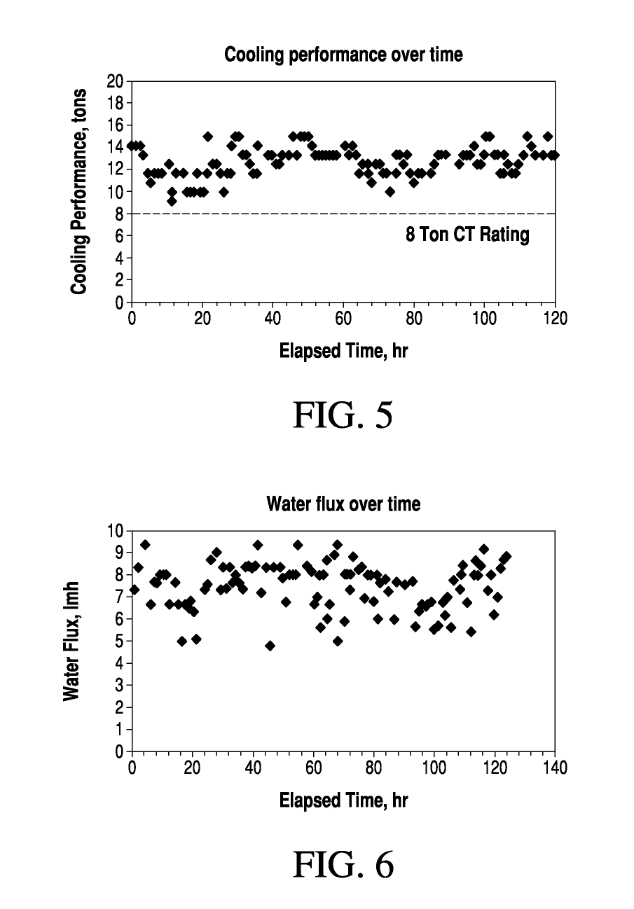

After performing these initial tests the full system was run with 35% glycerol in the cooling tower and tap water in the freshwater tank for a total of 123 hours over the course of 24 days. During this time water flux remained fairly constant with an average of 7.7 LMH. Cooling tower performance also remained fairly constant, providing an average of 13 tons (156,000 BTU/hr) of cooling (largely due to the low ambient temperatures which averaged 57° F.). Plots of the performance are shown in FIGS. 5 and 6.

1. A method for cooling hot process fluid, comprising:
(a) conveying through a first side of a heat exchanger the hot process fluid, and conveying through a second side of the heat exchanger an organic osmolyte solution which absorbs heat from the hot fluid;
(b) conveying the organic osmolyte solution to a cooling tower;
(c) diluting the organic osmolyte solution with water produced by a forward osmosis element, to produce diluted osmolyte solution; and
(d) conveying diluted osmolyte solution through the second side of the heat exchanger.

2. The method of claim 1, wherein the water produced in step (c) by the forward osmosis element is extracted from a membrane bioreactor; sea water; landfill leachate; oil drilling mud; gas drilling mud; produced water; flowback water; refinery wastewater; pulp manufacturing wastewater; paper manufacturing wastewater; pharmaceutical processing wastewater; water obtained from concentrating food substances; and water obtained from concentrating pharmaceuticals.

3. The method of claim 1, wherein the organic osmolyte is liquid in its pure state at ambient temperatures.

4. The method of claim 1, wherein the osmolyte is one or more selected from the group consisting of the following: trimethylamine N-oxide (TMAO), dimethylsulfoniopropionate, trimethylglycine, sarcosine, glycerophosphorylcholine, myo-inositol, taurine, betaines, amino acids, polyols, monosaccharides, disaccharides, polysaccharides, methylamines, methylsulfonium compounds, urea and glyceryl triacetate, polyvinyl alcohol, neoagarobiose, trehalose, and natural extracts.

5. The method of claim 4, wherein
the amino acid is selected from the group consisting of Histidine, Alanine, Isoleucine, Arginine, Leucine, Asparagine, Lysine, Aspartic acid, Methionine, Cysteine, Phenylalanine, Glutamic acid, Threonine, Glutamine, Tryptophan, Glycine, Valine, Ornithine, Proline, Selenocysteine, Serine, Taurine and Tyrosine;
the polyol is selected from the group consisting of ethylene glycol, propylene glycol, glycerol and polyethylene glycol;
the monosaccharide is selected from the group consisting of glucose and fructose;
the disaccharide is selected from the group consisting of sucrose and lactose;
the polysaccharide is selected from the group consisting of cellulose, polydextrose and amylose; and
the natural extract is selected from quillaia and lactic acid.

6. The method of claim 1, further comprising subjecting the diluted osmolyte to electrodialysis to remove excess salts.

7. A forward osmosis system for use with a heat exchanger and a cooling tower using an organic osmolyte solution as cooling tower water, the system comprising a forward osmosis membrane element for diluting a stream of organic osmolyte solution exiting the cooling tower.

8. The system of claim 7, wherein the forward osmosis membrane element uses a feed solution for the forward osmosis membrane element selected from the group consisting of: membrane bioreactor water; sea water; landfill leachate; oil drilling mud; gas drilling mud; produced water; flowback water; refinery wastewater; pulp manufacturing wastewater; paper manufacturing wastewater; pharmaceutical processing wastewater; water obtained from concentrating food substances; and water obtained from concentrating pharmaceuticals.

9. The system of claim 7, wherein the organic osmolyte is selected from the group consisting of: trimethylamine N-oxide (TMAO), dimethylsulfoniopropionate, trimethylglycine, sarcosine, glycerophosphorylcholine, myo-inositol, taurine, betaines, amino acids, polyols, monosaccharides, disaccharides, polysaccharides, methylamines, methylsulfonium compounds, urea and glyceryl triacetate, polyvinyl alcohol, neoagarobiose, trehalose, and natural extracts.

10. The system of claim 7, wherein: the amino acid is selected from the group consisting of Histidine, Alanine, Isoleucine, Arginine, Leucine, Asparagine, Lysine, Aspartic acid, Methionine, Cysteine, Phenylalanine, Glutamic acid, Threonine, Glutamine, Tryptophan, Glycine, Valine, Ornithine, Proline, Selenocysteine, Serine, Taurine and Tyrosine;
the polyol is selected from the group consisting of ethylene glycol, propylene glycol, glycerol and polyethylene glycol;
the monosaccharide is selected from the group consisting of glucose and fructose;
the disaccharide is selected from the group consisting of sucrose and lactose;
the polysaccharide is selected from the group consisting of cellulose, polydextrose and amylose; and
the natural extract is selected from quillaia and lactic acid.

11. The system of claim 7, further comprising an electrodialysis unit for removing salts from diluted organic osmolyte solution exiting the forward osmosis membrane element.

12. A cooling tower system comprising:
(a) a heat exchange loop comprising:
a heat exchanger having a first side and a second side, and
a first conduit for conveying hot process fluid through the first side of the heat exchanger;
(b) a cooling tower;
(c) a second conduit for conveying an organic osmolyte solution through the second side of the heat exchanger into the cooling tower;
(d) a forward osmosis membrane element for producing dilute organic osmolyte solution;
(e) a third conduit for conveying concentrated organic osmolyte solution exiting the bottom of the cooling tower to the forward osmosis membrane element; and
(f) a fourth conduit for conveying diluted organic osmolyte solution exiting the forward osmosis membrane element to the second side of the heat exchanger.

13. The cooling tower system of claim 12, further comprising an electrodialysis unit for removing salts from diluted organic osmolyte solution exiting the forward osmosis membrane element.
